(19) United States
(12) Patent Application Publication
(10) Pub. No.: US 2020/0347273 A1
(43) Pub. Date: Nov. 5, 2020

(54) RELEASE LINERS FOR LASER CUT ADHESIVES

(71) Applicant: 3M INNOVATIVE PROPERTIES COMPANY, St. Paul, MN (US)

(72) Inventors: Andrew J. Stockholm, Stillwater, MN (US); Joshua J. Loga, River Falls, MN (US); Albert I. Everaerts, Tucson, AZ (US)

(21) Appl. No.: 16/760,769

(22) PCT Filed: Nov. 19, 2018
(86) PCT No.: PCT/US2018/061730

§ 371 Date: Apr. 30, 2020

Related U.S. Application Data
(60) Provisional application No. 62/589,266, filed on Nov. 21, 2017.

(51) Int. Cl. C09J 7/38; C09J 7/40

(52) U.S. Cl. CPC C09J 7/385; C09J 2423/005; C09J 7/401

(57) ABSTRACT

Various embodiments described herein relate to a laminate. The laminate includes a release liner comprising at least one polyolefin and an adhesive layer. The adhesive layer contacts a region of a first major surface of the release liner. Upon exposure to laser electromagnetic radiation, the adhesive layer is configured to absorb at least 55% (in some embodiments, at least 60%, 65%, 70%, 75%, 80%, 85%, 90%, 95%, or even 100%) of the laser electromagnetic radiation and the release liner absorbs no greater than 45% (in some embodiments, no greater than 40%, 35%, 30%, 25%, 20%, 15%, 10%, 5%, or even 0%) of the laser electromagnetic radiation.

### CROSS REFERENCE TO RELATED APPLICATION

This application claims the benefit of U.S. Provisional Patent Application No. 62/589,266, filed Nov. 21, 2017, the disclosure of which is incorporated by reference herein in its entirety.

### BACKGROUND

Adhesives may be deposited on a release liner prior to application to a final substrate. Before application to a final substrate, the adhesive may be cut to a predetermined shape. However, cutting the adhesive (e.g., with a laser) may result in cutting or at least melting a portion of the release liner, which may result in a tighter bond formed between the adhesive and the release liner. When the release liner is removed, breaking the tight bond between the adhesive and release liner may result in adhesive remaining adhered to the release liner, thereby damaging the adhesive layer.

### SUMMARY

Various embodiments disclosed relate to a laminate. In one aspect, the laminate comprises:

a release liner comprising at least one polyolefin; and

an adhesive layer, the adhesive layer contacting a region of a first major surface of the release liner,

wherein upon exposure to laser electromagnetic radiation, the adhesive layer is configured to absorb at least 55% (in some embodiments, at least 60%, 65%, 70%, 75%, 80%, 85%, 90%, 95%, or even 100%) of the laser electromagnetic radiation and the release liner absorbs no greater than 45% (in some embodiments, no greater than 40%, 35%, 30%, 25%, 20%, 15%, 10%, 5% or even 0%) of the laser electromagnetic radiation.

In a second aspect, a method of processing a laminate is disclosed. The method may include:

providing or receiving a release liner comprising at least one polyolefin; and an adhesive layer, the adhesive layer contacting a region of a first major surface of the release liner,

wherein upon exposure to laser electromagnetic radiation, the adhesive layer is configured to absorb at least 55% (in some embodiments, at least 60%, 65%, 70%, 75%, 80%, 85%, 90%, 95%, or even 100%) of the laser electromagnetic radiation and the release liner absorbs no greater than 45% (in some embodiments, no greater than 40%, 35%, 30%, 25%, 20%, 15%, 10%, 5% or even 0%) of the laser electromagnetic radiation; and

exposing the laminate to a source of laser electromagnetic radiation having a wavelength in a range of from 0.10 to 15 (in some embodiments, in a range from 0.2 to 14, 0.3 to 13, 8 to 12, or even 9 to 11) micrometers to form an opening through the optically clear adhesive.

Various exemplary embodiments of the present disclosure offer certain advantages, some of which are unexpected. According to various embodiments of the present disclosure, an adhesive that is coated on a polyolefin-free liner, such as a polyethylene terephthalate liner, a paper liner, or a co-polyester liner, that is subsequently cut may cause the edge of the cut adhesive to melt or burn and subsequently bond to the bottom of the polyolefin-free liner, such as a polyethylene terephthalate liner. According to various embodiments, the polyolefin-free or polyethylene terephthalate liner may be substituted with a liner including a polyolefin such as polypropylene, which may be cut at a different wavelength than the adhesive thereby avoiding melting and bonding of the liner with the adhesive. According to various embodiments of the present disclosure, cutting an adhesive that is against the polyolefin liner, as opposed to the polyolefin-free or polyethylene terephthalate liner, may create a light tack, as opposed to the stronger bond, around the edge of the part which may function as a delivery aid such that a release force required to remove a first liner may be the same or greater than a release force required to remove a second liner without creating liner confusion. According to various embodiments of the present disclosure, the adhesive cut against a polyolefin liner may be successfully integrated within an exemplary electronic device such as a flexible electronic device because the lack of a tight bond formed against a liner that includes a polyolefin results in less damage to the adhesive and a lower release force than a corresponding adhesive that is cut against a liner that is free of the polyolefin, for example includes polyethylene terephthalate. According to various embodiments an adhesive that is damaged by removing it from a polyolefin-free liner or polyethylene terephthalate liner may result in the adhesive layer having decreased or unacceptable optical properties. According to various embodiments, a lower release force may also help to prevent damage to a fragile substrate, such an optical light emitting diode panel, when the liner has to be removed from the adhesive. Moreover, according to various embodiments, damage to the adhesive layer by losing material can render it unusable for lamination. According to various embodiments, an adhesive that is damaged by removing it from a polyolefin-free liner or polyethylene terephthalate may result in the adhesive layer having decreased strength or resiliency. Additionally, according to various embodiments damaging the adhesive may make it difficult for the adhesive to be cut to a proper shape.

### BRIEF DESCRIPTION OF THE FIGURES

The drawings illustrate generally, by way of example, but not by way of limitation, various embodiments discussed in the present document.

FIG. 1 is a sectional view of an exemplary laminate described herein.

FIG. 2 is a sectional diagram of another exemplary laminate described herein.

FIG. 3 is a sectional view of an exemplary electronic device described herein.

FIG. 4 is a photograph of a cross-section of the exemplary laminate of FIG. 2, described herein.

FIG. 5 is a photograph of a cross-section another exemplary laminate described herein.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include at least one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts may be carried out in any order without departing from the principles of the disclosure, except when a temporal or operational sequence is explicitly recited. Furthermore, specified acts may be carried out concurrently unless explicit claim language recites that they be carried out separately. For example, a claimed act of doing X and a claimed act of doing Y may be conducted simultaneously within a single operation, and the resulting process will fall within the literal scope of the claimed process.

The term “about” as used herein may allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least 50%, 60%, 70%, 80%, 90%, 95%, 96%, 97%, 98%, 99%, 99.5%, 99.9%, 99.99%, or at least 99.999%, or even 100%.

The term “organic group” as used herein refers to any carbon-containing functional group. Exemplary functional groups include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Exemplary organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂ N(R)C(O)R, (CH₂)₀₋₂ N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R may be hydrogen (in examples that include other carbon atoms) or a carbon-based moiety, and wherein the carbon-based moiety may be substituted or unsubstituted.

The term “substituted” as used herein in conjunction with a molecule or an organic group as defined herein refers to the state in which at least one hydrogen atoms contained therein are replaced by at least one non-hydrogen atoms. The term “functional group” or “substituent” as used herein refers to a group that may be or is substituted onto a molecule or onto an organic group. Exemplary substituents or functional groups include a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Exemplary substituents that may be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂ N(R)C(O)R, (CH₂)₀₋₂ N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R may be hydrogen or a carbon-based moiety; for example, R may be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms may together with the nitrogen atom or atoms form a heterocyclyl.

The term “alkyl” as used herein refers to straight chain and branched alkyl groups and cycloalkyl groups having from 1 to 40 (in some embodiments, from 1 to 20, 1 to 12, or even 1 to 8) carbon atoms. Exemplary straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Exemplary substituted alkyl groups may be substituted at least one time with any of the groups listed herein (e.g., amino, hydroxy, cyano, carboxy, nitro, thio, alkoxy, and halogen groups).

The term “aryl” as used herein refers to cyclic aromatic hydrocarbon groups that do not contain heteroatoms in the ring. Thus, aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain 6 to 14 carbons in the ring portions of the groups. Aryl groups may be unsubstituted or substituted, as defined herein. Exemplary representative substituted aryl groups may be mono-substituted or substituted more than once, such as a phenyl group substituted at any of at least one of 2-, 3-, 4-, 5-, or 6-positions of the phenyl ring, or a naphthyl group substituted at any of at least one of 2- to 8-positions thereof.

The term “heterocyclyl” as used herein refers to aromatic and non-aromatic ring compounds containing at least three ring members, of which at least one is a heteroatom such as N, O, and S.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight may be determined using light scattering, small angle neutron scattering, X-ray scattering, and sedimentation velocity. When not otherwise specified molecular weights are weight average molecular weights.

FIG. 1 is a sectional view of an exemplary embodiment of laminate 10. As shown, laminate 10 includes first release liner 12 with adhesive layer 14 disposed thereon. As described further herein, first release liner 12 includes at least one polyolefin component. As described further herein adhesive layer 14 may be an optically clear adhesive. Adhesive layer 14 contacts a region of first release liner 12. The region is defined by a surface area of a major surface of first release liner 12. As shown adhesive layer contacts 100% surface area of a major surface of release liner 12.

Adhesive layer 14 includes openings or cuts 16. As described further herein openings 16 may be formed by exposing laminate 10 to laser electromagnetic radiation. The extent to which opening 16 extends beyond adhesive layer 14 and into first release liner 12, or causes first release liner 12 to at least partially melt, may be a function of the ability of the respective materials of first release liner 12 and adhesive layer 14 to absorb laser electromagnetic radiation. For example, upon exposure to laser electromagnetic radiation, adhesive layer 14 may be configured to absorb at least 55% (in some embodiments, at least 60%, 65%, 70%, 75%, 80%, 85%, 90%, 95%, or even 100%) of the laser electromagnetic radiation whereas first release liner 12 may absorb no greater than 45% (in some embodiments, no greater than 40%, 35%, 30%, 25%, 20%, 15%, 10%, 5% or even, 0%) of the laser electromagnetic radiation. The difference in the absorbance between first release liner 12 and adhesive layer 14 may be desirable for many reasons as further described herein.

As describe herein, first release liner 12 includes at least one polyolefin. The polyolefin may be present in a range from 70 wt. % to 100 wt. % (in some embodiments, in a range from 75 wt. % to 100 wt. %, 80 wt. % to 100 wt. %, 85 wt. % to 100 wt. %, 90 wt. % to 100 wt. %, or even 95 wt. % to 100 wt. %), based on the total weight of the of first release liner 12. Exemplary polyolefins may include at least one of polyethylene, polypropylene, polymethylpentene, polybutene-1, polyisobutylene, or a copolymer thereof. When the polyolefin is a copolymer, the copolymer may be arranged as a block copolymer, alternate copolymer, or random copolymer. The at least one polyolefin may be present as a distribution of polyolefins having different weight average molecular weights.

The polyolefins may have any suitable melt flow index value. Exemplary melt flow index values may be in a range from 0.1 g/10 min. to 2000 g/10 min. (or in some embodiments, in a range from 10 g/10 min. to 1000 g/10 min., 100 g/10 min. to 500 g/10 min., or even 200 g/10 min. to 300 g/10 min.). As understood melt flow index is a measure of the ease of flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures. The melt flow index values herein would for example be measured at 190° C./2.16 kg using the ISO 1133-1 test method for a polyethylene polymer or 230° C./2.16 kg using ASTM D1238 for a polypropylene.

In embodiments where the polyolefin is polyethylene, the polyethylene may have a density in a range from 0.80 g/cm³ to 0.86 g/cm³ (in some embodiments, in a range from 0.81 g/cm³ to 0.85 g/cm³, or even from 0.82 g/cm³ to 0.84 g/cm³). In additional embodiments, the polyethylene may have a density in a range from 0.90 g/cm³ to 0.92 g/cm³ (in some embodiments, in a range from 0.90 g/cm³ to 0.91 g/cm³). In further embodiments, the polyethylene may have a density in a range from 0.92 g/cm³ to 0.96 g/cm³ (in some embodiments, in a range from 0.93 g/cm³ to 0.95 g/cm³).

In embodiments where the polyolefin is polypropylene, the polypropylene may be or include a biaxially oriented polypropylene (BOPP). Biaxially oriented polypropylenes may be formed by extruding a polypropylene film and stretching the film along two axes oriented at, for example, a ninety-degree angle with respect to each other. Film stretching along the two axes may be sequential or simultaneous. Biaxially oriented polypropylenes may increase strength and clarity of the polypropylene.

The material of first release liner 12 may be chosen to optimize the properties of laminate 10 in forming openings 16. To that end, it may desirable for first release liner 12 to include polyolefins with a limited ability to absorb laser electromagnetic radiation. As an example, first release liner 12 may be free of an amount (i.e., by at least one weight percentage) of at least one polymeric material or additive that would increase an absorbance of the release liner by greater than 5 (in some embodiments, greater than 10, 15, 20, 25, 30, 35, 40, 45, 50, 55, 60, 65, 70, 75, 80, 85, 90, or even by greater than 95) percent. In exemplary first release liners 12, liner 12 is free of (i.e., less than 1 percent by weight of the release liner) polyethylene terephthalate.

Adhesive layer 14 may comprise any suitable adhesive. For example, the adhesive may be a pressure-sensitive adhesive. Exemplary pressure-sensitive adhesives include a natural rubber-based adhesive, a synthetic rubber-based adhesive, a styrene block copolymer-based adhesive, a polyvinyl ether-based adhesive, a poly(methyl acrylate)-based adhesive, a polyolefin-based adhesive, polyurethane-based adhesive, polyester-based adhesive, or a silicone-based adhesive. As used herein “based” means contains at least 50% weight, based on the total weight of the adhesive. The balance of the adhesive may include additives such as tackifiers, plasticizers, oils, or fillers.

Other exemplary adhesives may include a reaction product of a polymerizable mixture including an alkyl acrylate ester, a polar monomer, and a free radical-generating initiator. Exemplary alkyl acrylates (e.g., acrylic acid alkyl ester monomers) include at least one of linear acrylates, branched monofunctional acrylates, or methacrylates of non-tertiary alkyl alcohols. The alkyl groups may have in a range from 1 to 24 carbon atoms. Exemplary monomers include at least one of 2-ethylhexyl (meth)acrylate, ethyl (meth)acrylate, methyl (meth)acrylate, n-propyl(meth)acrylate, isopropyl (meth)acrylate, pentyl (meth)acrylate, n-octyl (meth)acrylate, isooctyl (meth)acrylate, isononyl (meth)acrylate, n-butyl (meth)acrylate, isobutyl(meth)acrylate, hexyl (meth)acrylate, n-nonyl (meth)acrylate, isoamyl (meth)acrylate, n-decyl (meth)acrylate, isodecyl (meth)acrylate, dodecyl (meth)acrylate, isobornyl (meth)acrylate, cyclohexyl (meth)acrylate, phenyl meth(acrylate), benzyl meth(acrylate), isostearylacrylate, or 2-methylbutyl (meth)acrylate. In one exemplary embodiment, adhesive layer 14 includes only alkyl (meth)acrylate monomers with optional vinyl ester or styrenic monomers. In such cases, the modulus and glass transition temperature (T_{g}) of the composition may be adjusted by selecting combinations of low and high T_{g} yielding monomers. As used herein, the term “glass transition temperature” or “T_{g}” refers to the temperature at which a polymeric material transitions from a glassy state (e.g., brittleness, stiffness, and rigidity) to a rubbery state (e.g., flexible and elastomeric or viscous). In another exemplary embodiment, adhesive layer 14 may include in a range from 60 to 99 (in some embodiments, in a range from 65 to 95, or even 70 to 95) parts by weight of the alkyl(meth)acrylate ester having in a range from 1 to 24 carbon atoms in the alkyl group.

Exemplary embodiments of polar monomers may include polar copolymerizable monomers. Exemplary polar copolymerizable monomers include at least one of acrylic acid (AA), methacrylic acid, itaconic acid, fumaric acid, methacrylamide, N-alkyl substituted and N,N-dialkyl substituted acrylamides or methacrylamides (in which the alkyl group has no greater than 3 carbons), N-vinyl lactams, (meth)acrylamide, N-morpholino (meth)acrylate, N-vinyl pyrolidone, N-vinyl caprolactam, 2-hydroxy-ethyl(meth)acrylate, 2-hydroxy-propyl (meth)acrylate, 4-hydroxybutyl(meth)acrylate, 2-ethoxyethoxyethyl (meth)acrylate, 2-methoxyethoxyethyl(meth)acrylate, or combinations thereof. In an exemplary embodiment, adhesive layer 14 includes 1 to 40 (in some embodiments, 5 to 35, or even 5 to 30) parts by weight of the polar copolymerizable monomer.

Exemplary free-radical generating initiators include at least one of thermal initiators or photoinitiators. Exemplary thermal initiators include peroxides, such as benzoyl peroxide, its derivatives, or azo compounds. An exemplary azo compound is 2,2′-azobis-(2-methylbutyronitrile). A variety of peroxide or azo compounds are available that may be used to initiate thermal polymerization at a wide variety of temperatures. A photoinitiator may be used, either replacing the thermal initiator or used in combination with the thermal initiator. The one or more initiators may be added to the precursor mixtures in an amount of 0.01 to 2 (in some embodiments, 0.02 to 1, or even 0.02 to 0.5) part by weight of the polymerizable mixture.

The polymerizable mixture may further include a multifunctional cross-linker. In exemplary embodiments, the mixture may include thermal cross-linkers which are activated during a drying step of preparing adhesive layer 14 and cross-linkers that copolymerize during the polymerization step. Exemplary multifunctional cross-linkers include multifunctional isocyanates, at least one of multi-functional aziridine, epoxy compounds, 1,6-hexanediol diacrylate, an aromatic triisocyanate (obtained under the trade designation “DESMODUR N3300” from Bayer, Cologne, Germany) benzophenones, or 4-acryloxybenzophenones. In exemplary embodiments where the cross-linker is present, it may be in a range from 0.01 to 5 (in some embodiments, in a range from 0.01 to 4 part, or even 0.01 to 3) parts of the polymerizable mixture. Other crosslinking methods may be used, such as ionic crosslinking, acid-base crosslinking, or the use of physical crosslinking methods, such as by copolymerizing high T_{g} macromers (e.g., at least one of polymethylmethacrylate macromer or polystyrene macromer). Macromers may be used in a range from 1 to 20 parts by weight of the total monomer components in the assembly layer composition.

Adhesive layer 14 may be inherently tacky. If desired, tackifiers may be added to the polymerizable mixture before formation of the adhesive layer 14. Exemplary tackifiers include, at least one of rosin ester resins, aromatic hydrocarbon resins, aliphatic hydrocarbon resins, terpene, or terpene phenolic resins. When included, the tackifier is added to the polymerizable mixture in range from 1 to 50 (in some embodiments, in a range from 5 to 45, or even 10 to 30) parts by weight of the polymerizable mixture.

In exemplary embodiments, adhesive layer 14 may be free of (i.e., include less than 2 parts by weight of the polymerizable mixture) acid, which may help to eliminate indium tin oxide (ITO) and metal trace corrosion that otherwise could damage touch sensors and their integrating circuits or connectors.

Exemplary embodiments of the polymerizable mixture may include additional materials, such as at least one of molecular weight control agents, coupling agent, oils, plasticizers, antioxidants, UV stabilizers, UV absorbers, pigments, curing agents, polymer additives, or nanoparticles, and other additives. In exemplary embodiments, where adhesive layer 14 is optically clear (e.g., is an optically clear adhesive), other materials may be optionally added to the monomer mixture, provided that they do not significantly reduce the optical clarity of the adhesive layer 14. As used herein, the term “optically clear” refers to a material that has a luminous transmission of greater than 90 percent and a haze of less than 2 percent in the 400 to 700 nm wavelength range. Both the luminous transmission and the haze may be determined using, for example, ASTM-D 1003-00 (2000). In exemplary embodiments, adhesive layer 14 is visually free of bubbles.

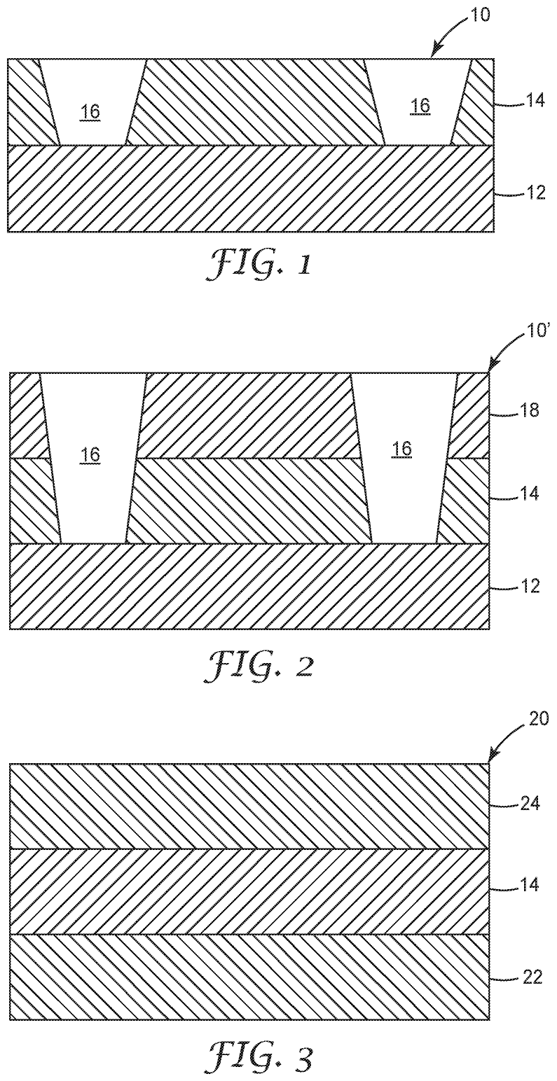

In exemplary embodiments, the polymerizable mixture may be pre-polymerized by exposure to heat or actinic radiation (e.g., to decompose initiators in the mixture). This may be done prior to the addition of a cross-linker and other components to form a coatable syrup to which, subsequently, one or more cross-linkers, other additives, and additional initiators may be added. The compounded mixture may then be coated on first release liner 12 and completely polymerized under inert atmosphere by additional exposure to ultraviolet radiation. Alternatively, the cross-linker, optional additives, and initiators may be added to monomers and the mixture may be both polymerized and cured in one step (e.g., as a liquid optically clear adhesive). The desired coating method and viscosity will determine which procedure is used. In another process, the assembly layer monomeric components may be blended with a solvent to form a mixture. The mixture may be polymerized by exposure to heat or actinic radiation (e.g., to decompose initiators in the mixture). A cross-linker and additional additives such as tackifiers and plasticizers may be added to the solvated polymer which may then be coated on a liner and run through an oven to dry off solvent to yield the coated adhesive film. The exemplary polymerizable mixtures may be coated by any variety of techniques known to those of skill in the art, such as roll coating, spray coating, knife coating, or die coating. FIG. 2 is a sectional diagram of laminate 10′. Laminate 10′ includes first release liner 12. Laminate 10′ also includes adhesive layer 14. Laminate 10′ further includes second release liner 18. Although shown as a release liner, second release liner 18 can be substituted with other film layers that are not configured to be removed. Exemplary film layers include optical films. Optical films may intentionally enhance, manipulate, control, maintain, transmit, reflect, refract, absorb, retard, or otherwise alter light that impinges upon a surface of the film. Films included in the laminates include classes of material that have optical functions, such as polarizers, interference polarizers, reflective polarizers, diffusers, colored optical films, mirrors, louvered optical film, light control films, transparent sheets, brightness enhancement film, anti-glare, and anti-reflective films, and the like. Films for the provided laminates can also include retarder plates such as quarter-wave and half-wave phase retardation optical elements. Other optically clear films include anti-splinter films and electromagnetic interference filters. These films may be cut with laser electromagnetic radiation.

Adhesive layer 14 contacts a portion second release liner 18. The region is defined by a surface area of a major surface of second release liner 18. As shown, adhesive layer 14 contacts 100% surface area of a major surface of second release liner 18. Second release liner 18 may be chemically the same (i.e., is the same composition, including percentages by weight of components) or different than the first release liner.

With respect to first release liner 12, second release liner 18 may be chemically different than first release liner 12. In exemplary embodiments, second release liner 18 is free (i.e., less than 1 percent by weight of the second release liner) of at least one polyolefin (e.g., polypropylene). In other exemplary embodiments, second release liner 18 may include polyethylene terephthalate. Second release liner 18 may have an electromagnetic absorbance value that is within at least 20 (in some embodiments, within at least 15, at least 10, or even within at least 5) percent of the absorbance value of adhesive layer 14.

Relative to each other, a thickness of at least one of adhesive layer 14, first release liner 12, or second release liner 18 may, independently, be in a range of from 0.012 mm to 1.00 mm (in some embodiments, in a range from 0.012 mm to 0.90 mm, 0.012 mm to 0.153 mm, 0.02 mm to 0.80 mm, 0.10 mm to 0.70 mm, 0.20 mm to 0.60 mm, or even 0.30 mm to 0.50 mm). Exemplary embodiments of either first release liner 12 or second release liner 18 may be sufficiently transparent in that either may allow for at least 85 (in some embodiments, at least 90, 95, or 100) percent transmission of visible light, relative to adhesive layer 14. In exemplary embodiments, at least one of first release liner 12 and second release liner 18 may include a release layer located facing adhesive layer 14. Exemplary release layers may include a polysiloxane or a fluorinated material.

FIG. 3 is a sectional view of electronic device 20. Electronic device 20 includes adhesive layer 14, which is attached to first substrate 22 and second substrate 24. Any one or both of first substrate 22 and second substrate 24 may be replaced with the optical films described herein. Adhesive layer 14 may be used in conjunction with many different types of electronic devices. An exemplary electronic device, however, may be flexible (e.g., foldable or rollable electronic device). Thus, substrates 22 and 24 may be flexible substrates and adhesive layer 14 may itself be flexible.

In exemplary embodiments including a flexible electronic device, the electronic device may resist fatigue over thousands of folding cycles over a broad temperature range from well below or above freezing such as in a range from −50° C. to 100° C. (in some embodiments, in a range from −40° C. to 90° C., −30° C. to 80° C., −20° C. to 70° C., −10° C. to 60° C., 0° C. to 50° C., 10° C. to 40° C., or even 20° C. to 30° C.). In addition, because electronic device 20 may be sitting static in the folded state for hours, adhesive layer 14 has minimal to no creep, preventing significant deformation of device 20, deformation which may be only partially recoverable, if at all. This permanent deformation of adhesive layer 14 could lead to optical distortions or Mura, which is not acceptable in the display industry. Thus, the adhesive layer 14 is able to withstand considerable flexural stress induced by folding a display device as well as tolerating high temperature, high humidity (HTHH) testing conditions. Additionally, adhesive layer 14 may have low storage modulus and high elongation over a broad temperature range (including well below freezing; thus, low glass transition temperatures are preferred) and may be cross-linked to produce an elastomer with little or no creep under static load.

During a folding or unfolding event, adhesive layer 14 may undergo significant deformation and cause stresses. The forces resistant to these stresses may be in part determined by the modulus and thickness of the layers of the device 20, including adhesive layer 14, first substrate 22 and second substrate 24. To ensure a low resistance to folding as well as adequate performance, generation of minimal stress and good dissipation of the stresses involved in a bending event, adhesive layer 14 may have a sufficiently low storage or elastic modulus, often characterized as shear storage modulus (G′). To further ensure that this behavior remains consistent over the expected use temperature range of such devices, G′ may have a minimal change over a broad and relevant temperature range. In one embodiment, the relevant temperature range is from −30° C. to 90° C. In one embodiment, the shear modulus is less than 2 MPa (in some embodiments, less than 1 MPa, less than 0.5 MPa, or even less than 0.3 MPa) over the entire relevant temperature range. Therefore, it may be preferred to position the glass transition temperature (T_{g}), the temperature at which the material transitions to a glassy state, with a corresponding change in G′ to a value typically greater than 10′ Pa, outside and below this relevant operating range. In an exemplary embodiment, the T_{g} of adhesive layer 14 in a flexible display is less than 10° C. (in some embodiments, less than −10° C., or even less than −30° C.). The T_{g} may be determined, for example, using a technique such as Dynamic Mechanical Analysis (DMA).

The thickness of adhesive layer 14 may be optimized according to the position in the flexible display device. Reducing the thickness of adhesive layer 14 may be preferred to decrease the overall thickness of the device as well as to reduce or minimize buckling, creep, or delamination failure of the composite structure.

The ability of adhesive layer 14 to absorb the flexural stress and comply with the radically changing geometry of a bend or fold may be characterized by the ability of such a material to undergo high amounts of strain or elongation under relevant applied stresses. This compliant behavior may be probed through a number of methods, including a conventional tensile elongation test as well as a shear creep test. In an exemplary embodiment, in a shear creep test, adhesive layer 14 exhibits a shear creep compliance (J) of at least 6×10⁶ l/Pa (in some embodiments, at least 20×10⁶ l/Pa, 50×10⁶ l/Pa, or even 90×10⁶l/Pa) under an applied shear stress in a range from 5 kPa to 500 kPa (in some embodiments, in a range from 20 kPa to 300 kPa, or even 50 kPa to 200 kPa). The test may be conducted at room temperature (e.g., 25° C.) or may be conducted at any temperature relevant to the use of the flexible device.

Adhesive layer 14 may also exhibit relatively low creep to avoid lasting deformations in the multilayer composite of a display following repeated folding or bending events. Material creep may be measured through a simple creep experiment in which a constant shear stress is applied to a material for a given amount of time. Once the stress is removed, the recovery of the induced strain is observed. In one embodiment, the shear strain recovery within 1 minute after removing the applied stress (at least one point of applied shear stress in a range from 5 kPa to 500 kPa) at room temperature is at least 50% (in some embodiments, at least 60%, 70%, 80%, or even 90%) of the peak strain observed at the application of the shear stress. The test is normally conducted at room temperature but could also be conducted at any temperature relevant to the use of the flexible device. Additionally, the ability of adhesive layer 14 to generate minimal or reduced stress and dissipate stress during a fold or bending event is relevant to the ability of adhesive layer 14 to avoid interlayer failure as well as its ability to protect the more fragile components of the flexible display assembly. Stress generation and dissipation may be measured using a traditional stress relaxation test in which a material is forced to and then held at a relevant shear strain amount. The amount of shear stress is then observed over time as the material is held at this target strain. In an exemplary embodiment, following 500% (in some embodiments, 600%, 700%, 800%, or even 900%) strain, the amount of residual stress (measured shear stress divided by peak shear stress) observed after 5 minutes is less than 50% (in some embodiments, less than 40%, 30%, 20%, or even 10%) of the peak stress. The test is normally conducted at room temperature but could also be conducted at any temperature relevant to the use of the flexible device. As an assembly layer, adhesive layer 14 must adhere sufficiently well to the adjacent layers within the display assembly to prevent delamination of the layers during the use of the device that includes repeated bending and folding actions. While the exact layers of the composite will be device specific, adhesion to a standard substrate such as polyethylene terephthalate (PET) may be used to gauge the general adhesive performance of the assembly layer in a traditional 180 degree peel test mode.

When adhesive layer 14 is placed between substrates 22 and 24 to form device 20 and device 20 is folded or bent and held at a relevant radius of curvature, the laminate may not buckle or delaminate between many use temperatures (e.g., −30° C. to 100° C.), an event that would represent a material failure in a flexible display device. In an exemplary embodiment, adhesive layer 14 does not exhibit failure when placed within a channel forcing a radius of curvature of less than 200 mm (in some embodiments, less than 100 mm, 50 mm, 20 mm, 10 mm, 5 mm, or even 2 mm) over a period of 24 hours. Furthermore, when removed from the channel and allowed to return from the bent orientation to its previously flat orientation, device 20 including adhesive layer 14 of the present invention may not exhibit lasting deformation and rather may rapidly return to a flat or nearly flat orientation. In an exemplary embodiment, when held for 24 hours and then removed from the channel that holds the laminate with a radius of curvature of less than 50 mm (in some embodiments, less than 20 mm, 10 mm, 5 mm, or even 3 mm), device 20 returns to a nearly flat orientation where the final angle in device 20, device 20 bend point and the return surface is less than 50 degrees (in some embodiments, less than 40 degrees, 30 degrees, 20 degrees, or even 10 degrees) within 1 hour after the removal of the laminate from the channel Stated alternatively, the included angle between the flat parts of the folded device 20 is in a range from 0 degrees in the channel to an angle of at least 130 degrees, (in some embodiments, at least 140 degrees, 150 degrees, 160 degrees, or even at least 170 degrees) 1 hour after removal of the laminate from the channel. This return may be obtained under normal usage conditions, including after exposure to durability testing conditions.

In addition to the static fold testing behavior described herein, a device including first and second substrates 22 and 24 bonded with adhesive layer 14 may not exhibit failures such as buckling or delamination during dynamic folding simulation tests. In one embodiment, the device 20 does not exhibit a failure event between all use temperatures over a dynamic folding test in free bend mode (i.e., no mandrel used) of greater than 10,000 (or in some examples greater than 20,000, 40,000, 60,000, 80,000, or even 100,000) cycles of folding with a radius of curvature of less than 50 mm (or even less than 20 mm, 10 mm, 5 mm, or even 3 mm).

To form electronic device 20, first substrate 22 may be directly applied to adhesive layer 14. In embodiments including laminate 10′, second release liner 18 is removed, following weeding of excess material formed by opening 16, and first substrate 22 is applied to the exposed adhesive layer 14. First release liner 12 is then removed from adhesive layer 14 and second substrate 24 is adhered to the exposed adhesive layer 14. The order in which liners 12 and 14 are removed can also be reversed. In exemplary embodiments, a minimum peel force required to remove second release liner 18 from adhesive layer 14 is in a range from 0.0019 N/mm to 0.011 N/mm (in some embodiments, in a range from 0.0038 N/mm to 0.0096 N/mm, or even 0.0057 N/mm to 0.0077 N/mm) less than a minimum peel force to remove first release liner 12 from adhesive layer 14. In some embodiments, a minimum peel force required to remove first release liner 12 from adhesive layer 14 is in a range from 0.0019 N/mm to 0.011 N/mm (in some embodiments, in a range from 0.0038 N/mm to 0.0096 N/mm, or even 0.0057 N/mm to 0.0077 N/mm) less than a minimum peel force to remove second release liner 18 from adhesive layer 14. In some embodiments, additional substrates and adhesives may be included to make a multi-layer stack. Pressure and/or heat may then be applied to form the flexible laminate.

In removing first release liner 12 and second release liner 18, it may be important to minimize the amount of damage sustained by adhesive layer 14 during removal of liners 12 and 18. For example, it may be desirable to release any of liners 12 and 18 such that adhesive from adhesive layer 14 does not remain on liners 12 and 18. If some adhesive is taken from adhesive layer 14, the properties of layer 14 and device 20 described herein may be altered. Missing pieces in adhesive layer 14, or deformations in adhesive layer 14, may result in decreases in performance (e.g., strength, modulus, or resiliency) or decreased optical properties, such as lower transparency or optical distortion as the light passes through the adhesive.

In some exemplary embodiments, one way to minimize damage is to include first release liner 12 and second release liner 18, as described herein. In forming opening 16, laminate 10 or 10′ may be exposed to a source of laser electromagnetic radiation (e.g., a carbon dioxide laser, a carbon monoxide laser, a fiber laser, an exciplex laser, or an ultraviolet laser) producing radiation having a wavelength in a range of from 0.10 to 15 (in some embodiments, in a range from 0.2 to 14, 0.3 to 13, 8 to 12, or even 9 to 11) to form opening 16 through at least one of adhesive layer 14 or, if present, second release liner 18. The intensity of the laser may be tuned to an optimal power. A power level of the laser can be in range from 50 W to 400 W (or in some embodiments, in a range from 100 W to 350 W, 150 W to 300 W, or even 200 W to 250 W). A diameter of the laser's focal spot may be in a range of from 150 micrometers to 300 micrometers (or in some embodiments, in a range from 170 micrometers to 270 micrometers, 200 micrometers to 240 micrometers, or even 210 micrometers to 230 micrometers). Forming openings 16 may be important for cutting adhesive layer 14 to an appropriate size or shape. The laser electromagnetic radiation may be applied to at least one of first layer 12 or second layer 18.

By virtue of the components of first release liner 12, the laser electromagnetic radiation is less likely to be absorbed by first release liner 12. In exemplary embodiments, following exposure to the source of laser electromagnetic radiation, first release liner 12 is free of (i.e., does not include) opening 16. This may be accomplished by setting the laser electromagnetic radiation source at a power level sufficient to create opening 16 in at least one of adhesive layer 14 and second release liner 18. However, the power of the laser electromagnetic radiation source may be adjusted such that opening 16 does extend into first release liner 12. The power of the laser electromagnetic radiation source may further be adjusted such that opening 16 does extend into first release liner 12, but by virtue of the components of liner 12, opening 16 extends into first release liner 12 to a lesser degree than a corresponding first release liner that is free of (i.e., does not include) the at least one polyolefin or includes polyethylene terephthalate.

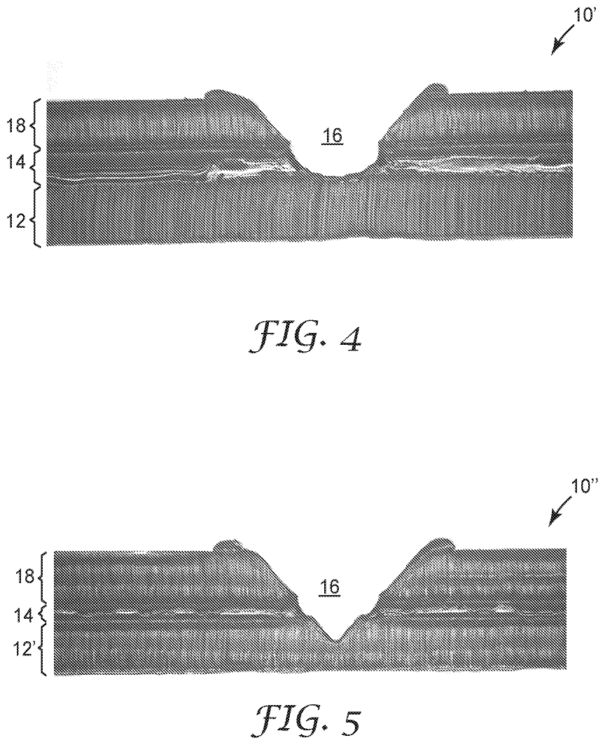

Irrespective of whether opening 16 extends into first release liner forming opening 16 in laminate 10 or laminate 10′, that includes a polyolefin or is free of a polyethylene terephthalate, may reduce or substantially eliminate the tendency of first release liner 12 to melt and subsequently bond to adhesive layer 14. Reducing or eliminating the tendency or first release liner 12 to melt may include melting less than 5 wt. % of the material of the first release liner. With less melting, the tendency of first release liner 12 and adhesive layer 14 to increase their bond is reduced. That is, by including polyolefins such as polypropylene in first release liner 12, as opposed to a material such as polyethylene terephthalate, opening 16 extends into first release liner 12 to a lesser degree and a propensity to form a stronger bond between first release liner 12 and adhesive layer 14 is decreased. This is shown in FIG. 4 and FIG. 5 respectively. FIG. 4 is a photograph of laminate 10′ in which first liner 12 includes polypropylene and opening 16 does not penetrate into first release liner 12, nor is significant interface deformation present (which would enhance bonding strength) between first release liner 12 and adhesive layer. In contrast, FIG. 5 is a photograph of an alternative laminate 10″ in which first release liner 12′ includes polyethylene terephthalate and is exposed to the same power of laser electromagnetic radiation for the same amount of time as laminate 10 or laminate 10′. As shown, opening 16 extends into first release liner 12′ and a significant interfacial deformation is present between first release liner 12′ and adhesive layer 14.

Opening 16 may be continuous and in exemplary embodiments may comprise a geometric shape chosen from a circle, an oval, an elliptical, a triangle, a square, a rectangle, a trapezoid, a pentagon, a hexagon, a heptagon, an octagon, or any other higher order polygon. Alternatively, opening 16 may be discontinuous and placed at a predetermined location in laminate 10 or laminate 10′.

The following exemplary embodiments are provided, the numbering of which is not to be construed as designating levels of importance:

1A. A laminate comprising:

a release liner comprising at least one polyolefin; and

an adhesive layer, the adhesive layer contacting a region of a first major surface of the release liner, wherein upon exposure to laser electromagnetic radiation, the adhesive layer is configured to absorb at least 55% (in some embodiments, at least 60%, 65%, 70%, 75%, 80%, 85%, 90%, 95%, or even 100%) of the laser electromagnetic radiation and the release liner absorbs no greater than 45% (in some embodiments, no greater than 40%, 35%, 30%, 25%, 20%, 15%, 10%, 5%, or even 0%) of the laser electromagnetic radiation.
2A. The laminate of Exemplary Embodiment 1A, wherein the at least one polyolefin is present in a range from 70 wt. % to 100 wt. % (in some embodiments, in a range from 75 wt. % to 100 wt. %, 80 wt. % to 100 wt. %, 85 wt. % to 100 wt. %, 90 wt. % to 100 wt. %, or even 95 wt. % to 100 wt. %), based on the total weight of the of the release liner.
3A. The laminate of either Exemplary Embodiment 1A or 2A, wherein the at least one polyolefin is at least one of polyethylene, polypropylene, polymethylpentene, polybutene-1, polyisobutylene, or a copolymer thereof.
4A. The laminate of Exemplary Embodiment 3A, wherein the polyethylene has a density in a range from 0.80 g/cm³ to 0.86 g/cm³ (in some embodiments, in a range from 0.81 g/cm³ to 0.85 g/cm³, or even 0.82 g/cm³ to 0.84 g/cm³).
5A. The laminate of Exemplary Embodiment 3A, wherein the polyethylene has a density in a range from 0.90 g/cm³ to 0.92 g/cm³ (in some embodiments, in a range from 0.90 g/cm³ to 0.91 g/cm³).
6A. The laminate of Exemplary Embodiment 3A, wherein the polyethylene has a density in a range from 0.92 g/cm³ to 0.96 g/cm³ (in some embodiments, in a range from 0.93 g/cm³ to 0.95 g/cm³).
7A. The laminate of Exemplary Embodiment 3A, wherein the polypropylene comprises a biaxially oriented polypropylene.
8A. The laminate of any preceding A Exemplary Embodiment, wherein the release liner allows for at least 85 (in some embodiments at least 90, 95, or 100) percent transmission of visible light.
9A. The laminate of any preceding A Exemplary Embodiment, wherein the release liner is free of an amount (i.e., by at least one weight percentage) of at least one polymeric material or additive that would increase an absorbance of the release liner by greater than 5 percent (in some embodiments, by greater than 10, 15, 20, 25, 30, 35, 40, 45, 50, 55, 60, 65, 70, 75, 80, 85, 90, or even greater than 95) percent of the laser electromagnetic radiation.
10A. The laminate of any preceding A Exemplary Embodiment, wherein the release liner is free of (i.e., less than 1 percent by weight of the release layer) polyethylene terephthalate.
11A. The laminate of any preceding A Exemplary Embodiment, further comprising a film layer, wherein a portion of the adhesive layer is contacting a region of the film layer.
12A. The laminate of Exemplary Embodiment 11A, wherein the film layer is an optical film.
13A. The laminate of any preceding A Exemplary Embodiment, wherein the release liner is a first release liner and the film layer is a second release liner, and wherein a portion of the adhesive layer is contacting a region of a major surface of the second release liner.
14A. The laminate of Exemplary Embodiment 13A, wherein the second release liner is chemically the same (i.e., includes the same percentages by weight of components) or different than the first release liner.
15A. The laminate of Exemplary Embodiment 14A, wherein the second release liner is chemically different (i.e., includes at least one component that differs by at least 0.5 weight percent) than the first release liner.
16A. The laminate of any of Exemplary Embodiments 14A to 15A, wherein the second release liner is free (i.e., less than 1 percent by weight of the second release liner) of polyolefins.
17A. The laminate of any of Exemplary Embodiments 14A to 16A, wherein the second release liner is free (i.e., less than 1 percent by weight of the second release liner) of polypropylene.
18A. The laminate of any one of Exemplary Embodiments 14A to 17A, wherein the second release liner has an absorbance value that is within at least 20 (in some embodiments, within at least 15, 10, or even within at least 5) percent of the absorbance value of the adhesive layer.
19A. The laminate of any preceding A Exemplary Embodiment wherein both the first release liner and the second release liner comprise a release layer located facing the adhesive layer.
20A. The laminate of Exemplary Embodiment 19A, wherein the release layer comprises at least one of a polysiloxane or a fluorinated compound.
21A. The laminate of any preceding A Exemplary Embodiment, wherein the adhesive layer comprises at least one of a natural rubber-based adhesive, a synthetic rubber-based adhesive, a styrene block copolymer-based adhesive, a polyvinyl ether-based adhesive, a poly(methyl acrylate)-based adhesive, a polyolefin-based adhesive, polyurethane-based adhesive, polyester-based adhesive, or a silicone-based adhesive (where “-based” means contains at least 50% weight, based on the total weight of the adhesive).
22A. The laminate of any preceding A Exemplary Embodiment, wherein the adhesive layer is a reaction product of a polymerizable mixture comprising:

at least one alkyl acrylate ester;

at least one polar monomer; and

at least one free radical-generating initiator.

23A. The laminate of any preceding A Exemplary Embodiment, wherein the adhesive layer is an optically clear adhesive layer.
24A. The laminate of any one of Exemplary Embodiments 22A or 23A, wherein the alkyl acrylate ester comprises in a range from 1 to 24 (in some embodiments, in a range from 2 to 23, 3 to 22, 4 to 21, 5 to 20, 6 to 19, 7 to 18, 8 to 17, 9 to 16, 10 to 15, 9 to 14, or even 11 to 13) carbon atoms in the alkyl group.
25A. The laminate of any one of Exemplary Embodiments 22A to 24A, wherein the adhesive has a glass transition temperature, and wherein the glass transition temperature is in a range from −50° C. to 20° C. (in some embodiments, in a range from −40° C. to 20° C., −30° C. to 20° C., −20° C. to 20° C., −10° C. to 10° C., or even −5° C. to 5° C.).
26A. The laminate of any one of Exemplary Embodiments 22A to 25A, wherein the polar monomer is a copolymerizable polar monomer.
27A. The laminate of Exemplary Embodiment 26A, wherein the at least one polar copolymerizable monomer is at least one of acrylic acid, methacrylic acid, itaconic acid, fumaric acid, methacrylamide, N-alkyl acrylamide, N,N-dialkyl acrylamide, N-alkyl methacrylamide, N,N-dialkyl methacrylamide, N-vinyl lactam, a hydroxy alkyl (meth)acrylate, or a hydroxyalkyl (meth)acrylamide.
28A. The laminate of any preceding A Exemplary Embodiment, wherein a thickness of the adhesive, the first release liner, or the second release liner is independently in a range of from 0.012 mm to 1.00 mm (or in some embodiments, in a range from 0.012 mm to 0.90 mm, 0.012 mm to 0.153 mm, 0.02 mm to 0.80 mm, 0.10 mm to 0.70 mm, 0.20 mm to 0.60 mm, or even 0.30 mm to 0.50 mm).
1B. A method of processing the laminate of any preceding A Exemplary Embodiment, the method comprising:

exposing the laminate to a source of laser electromagnetic radiation having a wavelength in a range of from 0.10 to 15 (in some embodiments, in a range from 0.2 to 14, 0.3 to 13, 8 to 12, or even 9 to 11) to form an opening through at least one of the adhesive or the second release liner.

2B. The method of Exemplary Embodiment 1B, wherein the first release liner is free of (i.e., does not include) the opening.
3B. The method any one of Exemplary Embodiments 1B or 2B, wherein the opening extends into a thickness of the first release liner to a lesser degree than a corresponding first release liner that is free of (i.e., does not include) the at least one polyolefin.
4B. The method of any preceding B Exemplary Embodiment, wherein the opening extends into a thickness of the first release liner to a lesser degree than a corresponding first release liner that is free of polypropylene.
5B. The method of any preceding B Exemplary Embodiment, wherein the opening extends into a thickness of the first release liner to a lesser degree than a corresponding first release liner that comprises polyethylene terephthalate.
6B. The method of any preceding B Exemplary Embodiment, wherein upon exposure to the laser electromagnetic radiation a degree of melting of the first release liner is less than a degree of melting of a corresponding release liner that comprises polyethylene terephthalate.
7B. The method of any preceding B Exemplary Embodiment, wherein during exposure to the laser electromagnetic radiation, the first release liner is free of melting (i.e., less than 5 wt. % of the material of the first release liner).
8B. The method of any preceding B Exemplary Embodiment, wherein the opening is continuous and comprises at least one geometric shape.
9B. The method of Exemplary Embodiment 8B, wherein the geometric shape is a circle, an oval, an elliptical, a triangle, a square, a rectangle, a trapezoid, a pentagon, a hexagon, a heptagon, an octagon, or any other higher order polygon.
10B. The method of any preceding B Exemplary Embodiment, wherein the laser electromagnetic radiation is provided by at least one of a carbon dioxide laser, a carbon monoxide laser, a fiber laser, an exciplex laser, or an ultraviolet laser.
11B. The method of any preceding B Exemplary Embodiment, comprising removing the second release liner to expose the adhesive and applying a first substrate to the adhesive.
12B. The method of Exemplary Embodiment 11B, further comprising removing the first release liner to expose the adhesive and applying a second substrate to the adhesive to form an electronic device.
13B. The method of any one of Exemplary Embodiments 11B or 12B, wherein a minimum peel force required to remove the second release liner from the adhesive layer is in a range from 0.0019 N/mm to 0.011 N/mm (in some embodiments, in a range from 0.0038 N/mm to 0.0096 N/mm, or even 0.0057 N/mm to 0.0077 N/mm) less than a minimum peel force to remove the first release liner from the adhesive layer.
14B. The method of Exemplary Embodiment 13B, wherein a minimum peel force required to remove the first release liner from the adhesive layer is in a range from 0.0019 N/mm to 0.011 N/mm (in some embodiments, in a range from 0.0038 N/mm to 0.0096 N/mm, or even 0.0057 N/mm to 0.0077 N/mm) less than a minimum peel force to remove the second release liner from the adhesive layer.
15B. The method of any one of Exemplary Embodiments 12B to 14B, wherein at least one of the first substrate or the second substrate is a flexible substrate.
1C. An electronic device comprising formed according to the method of any one of Exemplary Embodiments 10B to 13B.
2C. The electronic device of Exemplary Embodiment 1C, wherein the electronic device is a flexible electronic display.
3C. The electronic device of any one of Exemplary Embodiments 1C or 2C, wherein the electronic device is free of exhibiting failure (e.g., buckling or delamination) when placed within a channel forcing a radius of curvature of less than 15 (in some embodiments, less than 10, 5, or even less than 1) mm over a period of 24 hours at room temperature.
4C. The electronic device of Exemplary Embodiment 3C, wherein the electronic device is free of exhibiting failure (e.g., buckling or delamination) when subjected to a dynamic folding test at room temperature of 10,000 cycles of folding with a radius of curvature of less than 15 (in some embodiments, less than 10, 5, or even less than 1) mm.

### EXAMPLES

Various embodiments of the present invention may be better understood by reference to the following Examples which are offered by way of illustration. The present invention is not limited to the Examples given herein.

Preparation of Laminates

### Example 1

Adhesive layer 14 was a 25 micrometer acrylic based foldable assembly layer as described in PCT Pat. Pub. No. WO 2016/196541 (Behling et al.), the disclosure of which is incorporated herein by reference, in the section titled “Examples 7-20: Preparation of Solventless Based Assembly Layer Samples”, and the details are those of Example 8 in Table 3. The adhesive was in laminate 10′ form, being between a 75-micrometer silicone-coated the composite will be device specific, adhesion to a standard substrate such as polyethylene (PET) low release second liner 18 (obtained under the trade designation “RF02N” from SKC Haas, Seoul, South Korea) and a 100-micrometer addition-cured silicone release coated biaxially-oriented polypropylene (BOPP) low release first liner 12.

The laminate was exposed to sufficient laser electromagnetic radiation to create a 25.4 mm×203.2 mm rectangular continuous outline cut through second release liner 18 and adhesive layer 14. This is shown in elevation cross-section as opening 16 in FIG. 2. A 9.4-micrometer CO₂ laser (obtained under the trade designation “DIAMOND E-400-I” from Coherent, Inc., Bloomfield, Conn.) was used, and its settings were adjusted to make the appropriate cut.

The portion of adhesive layer 14 and second release liner 18 located outside of the rectangular continuous outline were then removed by hand from the first release liner 12 leaving a 25.4 mm×203.2 mm rectangle of second release liner 18 and adhesive layer 14 on top of a larger piece of first release liner 12.

### Example 2

Example 2 was prepared as described for Example 1, except the adhesive was in laminate 10′ form, being between a 75-micrometer silicone-coated PET low release second liner 18 (RF02N) and a 100-micrometer addition-cured silicone release coated BOPP high release first liner 12.

### Example 3

Example 3 was prepared as described for Example 1, except the adhesive was in laminate 10″ form, being between a 75-micrometer silicone-coated PET low release second liner 18 (RF02N) and a 75-micrometer silicone coated PET high release first liner 12 (obtained from under the trade designation “RF12N” from SKC Haas).

### Comparative Example C-1

The laminate for Comparative Example C-1 was prepared as described for Example 1. However, rather than laser cutting the laminate, the laminate was flat die cut in a die cutting press (obtained under the trade designation “MP-200SR” from Akebono Machine Industries Co., Ltd., Konosu, Japan) using a die with 30 degree edge angle (obtained under the trade designation “FLEXIBLE PINNACLE DIE” from Tsukatani Hamono Mfg. Co., Ltd., Osaka, Japan) to create a 57 mm×121 mm rectangular continuous outline cut through second release liner 18 and adhesive layer 14. This is shown in elevation cross-section as opening 16 in FIG. 2. Care was taken to leave a light die mark in first release liner 12.

The portion of adhesive layer 14 and second release liner 18 located outside of the rectangular continuous outline were then removed by hand from the first release liner 12 leaving a 57 mm×121 mm rectangle of second release liner 18 and adhesive layer 14 on top of a larger piece of first release liner 12.

A summary of laminates described above is provided in Table 1, below.

TABLE 1

| | Cutting | | | |
|---|---|---|---|---|
| | Method for | | | |
| | Forming | Second Release | First Release | |
| Example | Opening 16 | Liner 18 | Liner 12 | Adhesive Layer 14 |
| 1 | Laser | 75-micrometer | 100-micrometer | 25-micrometer acrylic based |
| | | silicone coated | silicone coated | foldable assembly layer as |
| | | PET low release | BOPP low release | described in WO 2016/196541 |
| | | liner | liner | (Behling et al.), Ex. 8 |
| 2 | Laser | 75-micrometer | 100-micrometer | 25-micrometer acrylic based |
| | | silicone coated | silicone coated | foldable assembly layer as |
| | | PET low release | BOPP high | described in WO 2016/196541 |
| | | liner | release liner | (Behling et al.), Ex. 8 |
| 3 | Laser | 75-micrometer | 75-micrometer | 25-micrometer acrylic based |
| | | silicone coated | silicone coated | foldable assembly layer as |
| | | PET low release | PET high release | described in WO 2016/196541 |
| | | liner | liner | (Behling et al.), Ex. 8 |
| C-1 | Metal Die | 75-micrometer | 100-micrometer | 25-micrometer acrylic based |
| | | silicone coated | silicone coated | foldable assembly layer as |
| | | PET low release | BOPP low release | described in WO 2016/196541 |
| | | liner | liner | (Behling et al.), Ex. 8 |

Measurement of Second Liner Force of Release from Adhesive

Laminate 10′ of a specimen of an Example was adhered to a glass plate with a 2 kg. roller using double sided tape (obtained under the trade designation “3M #410” from 3M Company, St. Paul, Minn.) between first release liner 12 and the glass plate. Second release liner 18 was then removed at a 90 degree angle using a slip/peel tester (obtained, under the trade designation “IMASS SP-2100” from IMASS, Inc., Accord, Mass.) at a speed of 2.286 meters per minute. The average steady state peel force to remove second release liner 18 from adhesive layer 14 was recorded.

The results of second release liner 18 removal testing are provided in Table 2, below.

TABLE 2

| | Number of | Average Second Release Liner 18 Steady |
|---|---|---|
| Example | Samples Tested | State Peel (grams/25.4 mm) |
| 1 | 2 | 17.09 |
| 2 | 1 | 16.79 |
| 3 | 1 | 14.8 |
| C-1 | 10 | Not Measurable |

For Comparative Example C-1 (the die-cut specimens), the peel force of second release liner 18 is close to the peel force of first release liner 12. Thus, so-called liner confusion is likely to occur. Liner confusion is the condition where the adhesive does not stay exclusively with one of the liners during a peel test. Peel may occur at the unintended interface, due to the similar forces required for peel at the two adhesive interfaces. For Comparative Example C-1, ten specimens were peeled, and all ten exhibited at least some adhesive removal from the unintended interface. For Example 1, ten additional specimens were peeled, and none showed any adhesive removal from the unintended interface. For Examples 1-3, the higher force required to begin to remove first liner 12 at opening 16 (demonstrated below) prevents liner confusion from occurring.

Measurement of First Liner 12 Force of Release from Adhesive Layer 14 at Opening 16 and at Steady State

On a specimen of an Example, second release liner 18 was removed from adhesive layer 14 and the adhesive was then laminated to a glass substrate using a 2 kg. roller. First release liner 12 was then removed using a slip/peel tester (IMASS SP-2100) at a 90 degree angle at a speed of 2.286 meters per minute. Ten specimens were tested for each Example. Both the initial force needed to separate first release liner 12 from adhesive layer 14 at opening 16 and the average steady state peel force needed to continue to remove first release liner 12 from adhesive layer 14 away from opening 16 were recorded.

The results of release liner removal testing are provided in Table 3, below.

TABLE 3

| | | | | Ratio of First |
|---|---|---|---|---|
| | | Average First | Average First | Release Liner 12 |
| | | Release Liner 12 | Release Liner 12 | peel force from the |
| | Number | Peel force from the | Peel force from the | adhesive 14 at the |
| | of | adhesive 14 at the | adhesive 14 at | cut location 16 to |
| | Samples | cut location 16 | steady state | that at steady state |
| Example | Tested | (grams/25.4 mm) | (grams/25.4 mm) | (grams/25.4 mm) |
| 1 | 10 | 137.41 | 20.92 | 6.57:1 |
| 2 | 10 | 298.81 | 48.65 | 6.12:1 |
| 3 | 10 | 619.77 | 73.43 | 8.44:1 |

Specimens of Comparative Example C-1 were not testable due to liner confusion.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

1. A laminate comprising:
a release liner comprising at least one polyolefin; and
an adhesive layer, the adhesive layer contacting a region of a first major surface of the release liner,
wherein upon exposure to laser electromagnetic radiation, the adhesive layer is configured to absorb at least 55% of the laser electromagnetic radiation and the release liner absorbs no greater than 45% of the laser electromagnetic radiation.

2. The laminate of claim 1, wherein the at least one polyolefin is at least one of polyethylene, polypropylene, polymethylpentene, polybutene-1, polyisobutylene, or a copolymer thereof.

3. The laminate of claim 1, wherein the release liner is free of at least one polymeric material or additive that absorb greater than 5 percent of the laser electromagnetic radiation.

4. The laminate of claim 1, wherein the release liner is free of polyethylene terephthalate.

5. The laminate of claim 1, wherein the release liner is a first release liner and the laminate further comprises at least one of an optical film or a second release liner, and wherein a portion of the adhesive layer is contacting a region of a major surface of the optical film or second release liner.

6. The laminate of claim 1, wherein the second release liner is free of polyolefins.

7. The laminate of claim 1, wherein the adhesive layer is a reaction product of a polymerizable mixture comprising:
at least one alkyl acrylate ester;
at least one polar monomer; and
at least one free radical-generating initiator.

8. A method of processing a laminate, the method comprising:
providing or receiving laminate comprising:
a release liner comprising at least one polyolefin; and
an adhesive layer, the adhesive layer contacting a region of a first major surface of the release liner; and
exposing the laminate to a source of laser electromagnetic radiation having a wavelength in a range of from 0.1 to 15 micrometers to form an opening through at least one of the adhesive or the second release liner,
wherein upon exposure to laser electromagnetic radiation, the adhesive layer is configured to absorb at least 55% of the laser electromagnetic radiation and the release liner absorbs no greater than 45% of the laser electromagnetic radiation.

9. The method of claim 8, wherein the first release liner is free of the opening.

10. The method of claim 8, wherein the opening extends into a thickness of the first release liner to a lesser degree than a corresponding first release liner that is free of the at least one polyolefin.

11. The method of claim 8, wherein the opening extends into a thickness of the first release liner to a lesser degree than a corresponding first release liner that is free of polypropylene.

12. The method of claim 8, wherein the opening extends into a thickness of the first release liner to a lesser degree than a corresponding first release liner that comprises polyethylene terephthalate.

13. The method of claim 8, wherein a upon exposure to the laser electromagnetic radiation a degree of melting of the first release liner is less than a degree of melting of a corresponding release liner that comprises polyethylene terephthalate.

14. The method of claim 8, wherein during exposure to the laser electromagnetic radiation, the first release liner is free of melting.

15. The method of claim 8, wherein a minimum peel force required to remove the second release liner from the adhesive layer is in a range from 0.0019 N/mm to 0.011 N/mm less than a minimum peel force to remove the first release liner from the adhesive layer.
